(19) United States
(12) Patent Application Publication
(10) Pub. No.: US 2010/0235563 A1
(43) Pub. Date: Sep. 16, 2010

(54) METHOD FOR ENHANCING PERFORMANCE OF A FLASH MEMORY, AND ASSOCIATED PORTABLE MEMORY DEVICE AND CONTROLLER THEREOF

(76) Inventor: Hsu-Ping Ou, Hsinchu County (TW)

Correspondence Address: NORTH AMERICA INTELLECTUAL PROPERTY CORPORATION, P.O. BOX 506, MERRIFIELD, VA, 22116, US

(21) Appl. No.: 12/534,828

(22) Filed: Aug. 3, 2009

(30) Foreign Application Priority Data
Mar. 11, 2009 (TW) 098107873

(51) Int. Cl. G06F 12/00; G06F 12/02

(52) U.S. Cl. 711/103; 711/104; 711/E12.001; 711/E12.008

(57) ABSTRACT

A method for enhancing performance of a Flash memory includes: providing a random access memory (RAM); utilizing the RAM to temporarily store at least one virtual Flash block; and selectively moving data of the virtual Flash block to the Flash memory in order to write at least one new page in the Flash memory. An associated portable memory device and a controller thereof are also provided, where the controller includes: a read only memory (ROM) arranged to store a program code; and a microprocessor arranged to execute the program code to control the access to the Flash memory. In addition, the controller that executes the program code by utilizing the microprocessor selectively moves the data of the virtual Flash block to the Flash memory in order to write at least one new page in the Flash memory.

### BACKGROUND OF THE INVENTION

1. Field of the Invention

The present invention relates to a Flash memory, and more particularly, to a method for enhancing performance of a Flash memory, and to an associated portable memory device and a controller thereof.

2. Description of the Prior Art

As technologies of Flash memories progress in recent years, many kinds of portable memory devices, such as memory cards respectively complying with SD/MMC, CF, MS, and XD standards, are widely implemented in various applications. Therefore, the control of access to Flash memories in these portable memory devices has become an important issue.

Taking NAND Flash memories as an example, they can mainly be divided into two types, i.e. Single Level Cell (SLC) Flash memories and Multiple Level Cell (MLC) Flash memories. Each transistor that is considered a memory cell in SLC Flash memories only has two charge levels that respectively represent a logical value 0 and a logical value 1. In addition, the storage capability of each transistor that is considered a memory cell in MLC Flash memories can be fully utilized. More specifically, the voltage for driving memory cells in the MLC Flash memories is typically higher than that in the SLC Flash memories, and different voltage levels can be applied to the memory cells in the MLC Flash memories in order to record information of two bits (e.g. binary values 00, 01, 11, or 10) in a transistor that is considered a memory cell. Theoretically, the storage density of the MLC Flash memories may reach twice the storage density of the SLC Flash memories, which is considered good news for NAND Flash memory manufacturers who encountered a bottleneck of NAND Flash technologies.

As MLC Flash memories are cheaper than SLC Flash memories, and are capable of providing higher capacity than SLC Flash memories while the space is limited, MLC Flash memories have been a main stream for implementation of most portable memory devices on the market. However, various problems of the MLC Flash memories have arisen due to their unstable characteristics. For example, according to the related art, user data will get lost at any time in a situation where the quality of a Flash memory degrades due to long-term use. More particularly, in contrast to the SLC Flash memories, the upper limit of the erase count of each block of the MLC Flash memories is relatively low, which causes the problem of the unstable characteristics to become unacceptable.

Please note that the upper limit of the erase count of each block of Flash memories decreases while the scale of process is decreased. For example, the upper limit of the erase count of each block of Flash memories fabricated by utilizing the 50-nanometer process technology is less than the upper limit of the erase count of each block of Flash memories fabricated by utilizing the 60-nanometer process technology. By decreasing the scale of process, Flash memory manufacturers may achieve the goal of reducing costs. In this situation, they would be more severely impacted by the unstable characteristics mentioned above. Thus, a novel method is required for enhancing the control of data access to Flash memories, in order to guarantee the completeness of user data.

### SUMMARY OF THE INVENTION

It is therefore an objective of the claimed invention to provide a method for enhancing performance of a Flash memory, and to provide an associated portable memory device and a controller thereof, in order to solve the above-mentioned problem.

It is another objective of the claimed invention to provide a method for enhancing performance of a Flash memory, and to provide an associated portable memory device and a controller thereof, in order to maintain the performance of data access in a situation where the quality of the Flash memory degrades due to process variation (e.g. the scale of process is decreased).

It is another objective of the claimed invention to provide a method for enhancing performance of a Flash memory, and to provide an associated portable memory device and a controller thereof, in order to slow down the increase of the erase counts of the blocks in the Flash memory. Therefore, in contrast to the related art, portable memory devices that are implemented based upon the present invention surely have a longer lifetime.

According to a preferred embodiment of the claimed invention, a method for enhancing performance of a Flash memory comprises: providing a random access memory (RAM); utilizing the RAM to temporarily store at least one virtual Flash block; and selectively moving data of the virtual Flash block to the Flash memory in order to write at least one new page in the Flash memory.

While the method mentioned above is disclosed, an associated portable memory device is further provided. The portable memory device comprises: a Flash memory; a RAM; and a controller arranged to access the Flash memory, wherein the controller utilizes the RAM to temporarily store at least one virtual Flash block. In addition, the controller selectively moves data of the virtual Flash block to the Flash memory in order to write at least one new page in the Flash memory.

While the method mentioned above is disclosed, a controller of a portable memory device is further provided, where the controller is utilized for accessing a Flash memory. The controller comprises: a read only memory (ROM) arranged to store a program code; and a microprocessor arranged to execute the program code to control access to the Flash memory. In addition, the controller that executes the program code by utilizing the microprocessor utilizes a RAM to temporarily store at least one virtual Flash block. Additionally, the controller that executes the program code by utilizing the microprocessor selectively moves data of the virtual Flash block to the Flash memory in order to write at least one new page in the Flash memory.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram of a portable memory device according to a first embodiment of the present invention.

FIG. 2 is a flowchart of a method for enhancing performance of a Flash memory according to one embodiment of the present invention.

FIG. 3 and FIG. 4 illustrate a working flow regarding the method shown in FIG. 2 according to one embodiment of the present invention.

### DETAILED DESCRIPTION

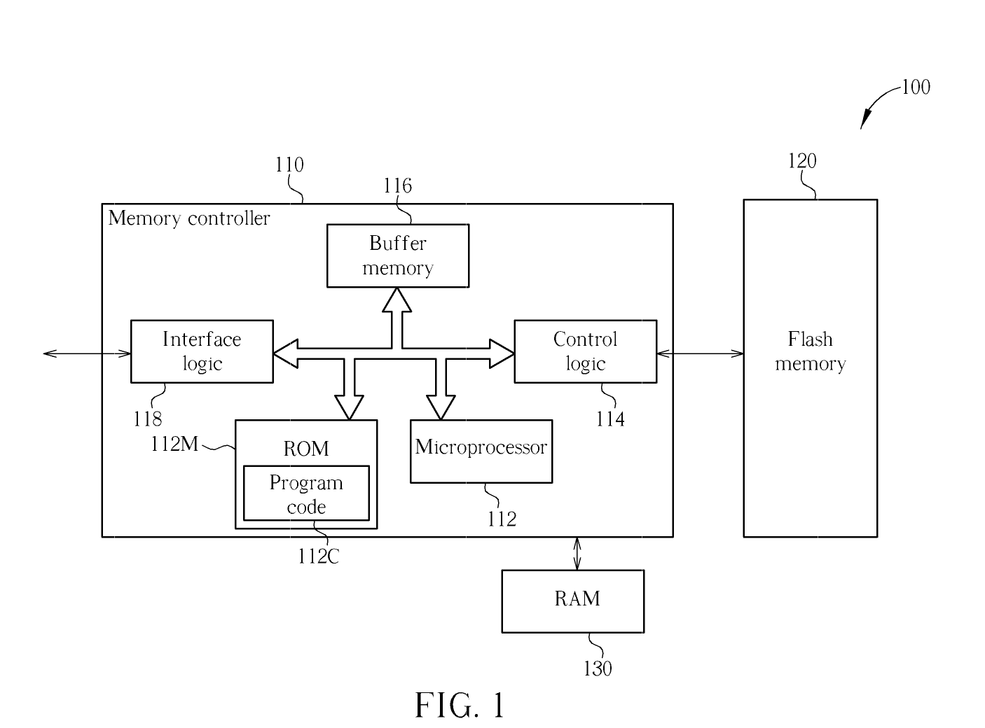

Please refer to FIG. 1, which illustrates a diagram of a portable memory device 100 according to a first embodiment of the present invention. In particular, the portable memory device 100 of this embodiment is a portable memory device, such as a memory card complying with SD/MMC, CF, MS, or XD standards. The portable memory device 100 comprises a Flash memory 120 and a random access memory (RAM) 130 such as a dynamic random access memory (DRAM), and further comprises a controller arranged to access the Flash memory 120, where the aforementioned controller of this embodiment is a memory controller 110. According to this embodiment, the memory controller 110 comprises a microprocessor 112, a read only memory (ROM) 112M, a control logic 114, a buffer memory 116, and an interface logic 118. The ROM 112M is arranged to store a program code 112C, and the microprocessor 112 is arranged to execute the program code 112C to control the access to the Flash memory 120.

Typically, the Flash memory 120 comprises a plurality of blocks, and the controller (e.g. the memory controller 110 that executes the program code 112C by utilizing the microprocessor 112) performs data erasure operations on the Flash memory 120 by erasing in units of blocks. In addition, a block can be utilized for recording a specific amount of pages, where the controller (e.g. the memory controller 110 that executes the program code 112C by utilizing the microprocessor 112) performs data writing operations on the Flash memory 120 by writing/programming in units of pages.

In practice, the memory controller 110 that executes the program code 112C by utilizing the microprocessor 112 is capable of performing various control operations by utilizing the internal components within the memory controller 110. For example, the memory controller 110 utilizes the control logic 114 to control access to the Flash memory 120 (e.g. operations of accessing at least one block or at least one page), utilizes the buffer memory 116 to perform buffering operations for the memory controller 110, and utilizes the interface logic 118 to communicate with a host device.

According to this embodiment, the controller (more particularly, the memory controller 110 that executes the program code 112C by utilizing the microprocessor 112) is capable of utilizing the RAM 130 to temporarily store at least one virtual Flash block, such as a single virtual Flash block. This is for illustrative purposes only, and is not meant to be a limitation of the present invention. According to a variation of this embodiment, the aforementioned at least one virtual Flash block may comprise a plurality of virtual Flash blocks.

In addition, the controller is capable of selectively moving data of the virtual Flash block to the Flash memory 120 or selectively copying data of the virtual Flash block to the Flash memory 120, in order to write at least one new page in the Flash memory 120. Therefore, once random access commands are frequently received, the present invention can maintain the performance of data access. In a situation where the quality of the Flash memory 120 degrades due to process variation (e.g. the scale of process is decreased), the present invention can still maintain the performance of data access.

As there is the RAM 130 installed in the portable memory device 100 of this embodiment, the controller can perform erasure management or writing management by accessing the virtual Flash block in the RAM 130, rather than frequently accessing temporarily blocks in the Flash memory 120 as suggested in the related art. Therefore, the present invention can effectively slow down the increase of the erase counts of the blocks in the Flash memory 120.

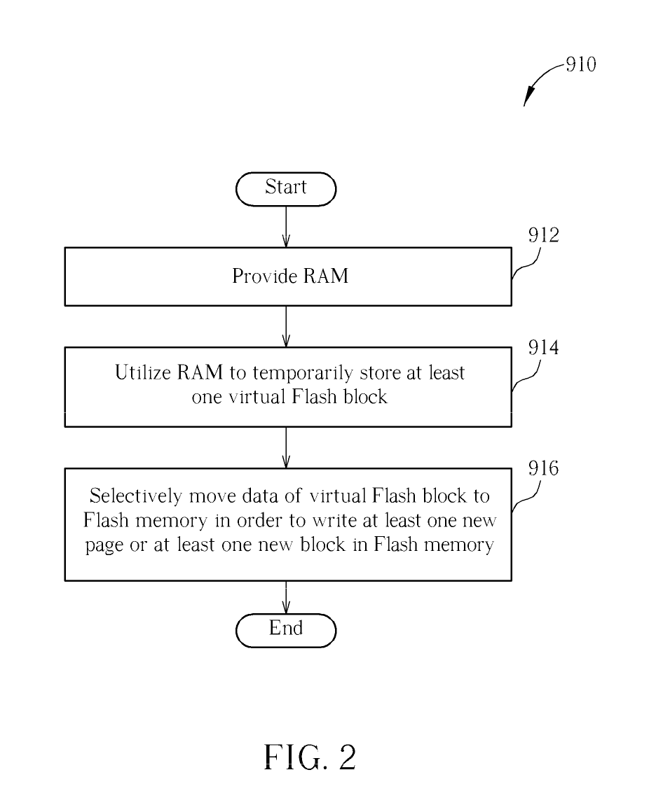

FIG. 2 is a flowchart of a method 910 for enhancing performance of a Flash memory according to one embodiment of the present invention. The method can be applied to the portable memory device 100 shown in FIG. 1, and more particularly, to the controller mentioned above (e.g. the memory controller 110 that executes the program code 112C by utilizing the microprocessor 112). In addition, the method can be implemented by utilizing the portable memory device 100 shown in FIG. 1, and more particularly, by utilizing the controller mentioned above. The method is described as follows.

In Step 912, provide a RAM, and more particularly, provide the RAM 130 (e.g. the aforementioned DRAM) within the portable memory device 100 shown in FIG. 1.

In Step 914, the controller mentioned above utilizes the RAM 130 to temporarily store at least one virtual Flash block.

In Step 916, the controller selectively moves data of the virtual Flash block to the Flash memory 120 in order to write at least one new page or at least one new block in the Flash memory 120.

Although the operation mentioned in Step 916 is described with moving data, this is for illustrative purposes only, and is not meant to be a limitation of the present invention. In practice, the controller can selectively copy data of the virtual Flash block to the Flash memory 120 in order to write at least one new page or at least one new block in the Flash memory 120.

According to this embodiment, when detecting that the host device mentioned above performs a file-close operation (e.g. an operation for closing a file) or sends a sleep command or a shutdown command, the controller immediately copies/moves the data of the virtual Flash block to the Flash memory 120 in order to write at least one page in the Flash memory 120. By utilizing such a protective mechanism, the present invention can prevent the data of the virtual Flash block from being lost when the file-close operation or sleep/shutdown is required.

According to a special case of this embodiment, the Flash memory 130 is fabricated by utilizing sub-60-nanometer (nm) process technology, i.e. process technology of a scale that is less than 60 nanometer. For example, the Flash memory 130 is fabricated by utilizing the newly developed 50-nanometer process technology. In a situation where the quality of the Flash memory 120 becomes worse than that of a product fabricated by utilizing the 60-nanometer process technology or the 70-nanometer process technology, the present invention can still maintain the performance of data access.

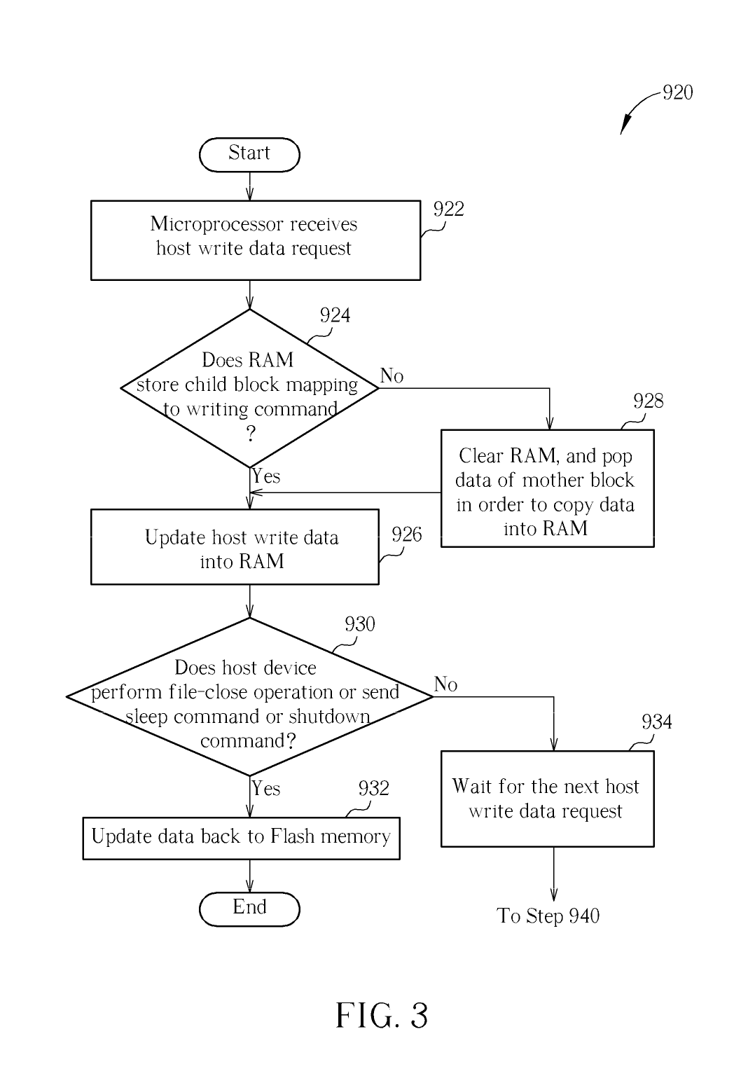

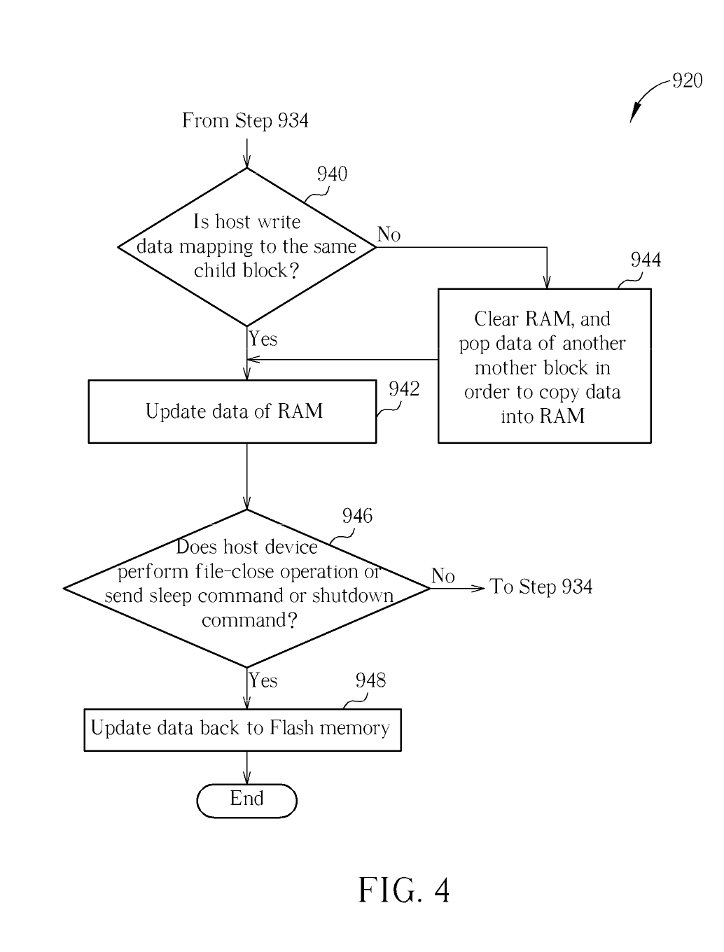

FIG. 3 and FIG. 4 illustrate a working flow 920 regarding the method 910 shown in FIG. 2 according to one embodiment of the present invention, where this embodiment is a variation of the embodiment shown in FIG. 2. Please refer to FIG. 3 first.

In Step 922, the microprocessor 112 receives a host write data request, where the host write data request asks for performing a data update operation or a data writing operation regarding a block of the Flash memory 120. The block mentioned in this step can be referred to as the mother block.

In Step 924, the controller checks whether the RAM 130 stores a block mapping to the mother block, where the block mapping to the mother block can be referred to as the child block. Here, the child block represents the virtual Flash block of this embodiment. When the controller detects that the RAM 130 stores the child block mapping to a writing command, Step 926 is entered; otherwise, Step 928 is entered.

In Step 926, update/write the host write data into the child block within the RAM 130. For example, the host write data request asks for performing a data update operation or a data writing operation regarding the mother block, and more particularly, a memory region ranging from the 10^{th} page to the 20^{th} page within the mother block. In an embodiment, the controller updates/writes the host write data into a memory region ranging from the 10^{th} page to the 20^{th} page within the child block in the RAM 130. That is, the controller substantially updates/writes the host write data into a memory region within the virtual Flash block at the same address as that within the mother block according to the host write data request.

In Step 928, the controller clears the RAM 130, and pops the data of the mother block in the Flash memory 120 according to the host write data request in order to copy the data into the RAM 130 for being utilized as the data of the child block. After Step 928 is executed, Step 926 is entered.

In Step 930, when the controller detects that the host device performs a file-close operation or detects that the host device sends a sleep command or a shutdown command, Step 932 is entered; otherwise, Step 934 is entered.

In Step 932, the controller immediately updates (e.g. copies/moves) the data of the RAM 130 (i.e. the data of the child block) back to the Flash memory 120.

In Step 934, the controller waits for the next host write data request, such as a new host write data request. After Step 934 is executed, Step 940 shown in FIG. 4 is entered.

In Step 940, when the controller detects that host write data associated to the host write data request mentioned in Step 934 is mapping to the same child block as that mentioned above, which means that the host write data request mentioned in Step 934 asks for performing a data update operation or a data writing operation regarding the same mother block as that mentioned above, Step 942 is entered; otherwise, Step 944 is entered.

In Step 942, the controller utilizes the host write data to update the data of the RAM 130 according to the host write data request.

In Step 944, the controller clears the RAM 130, and pops the data of another mother block in the Flash memory 120 according to the host write data request in order to copy the data into the RAM 130 for being utilized as the data of the child block. After Step 944 is executed, Step 942 is entered.

In Step 946, when the controller detects that the host device performs a file-close operation or detects that the host device sends a sleep command or a shutdown command, Step 948 is entered; otherwise, Step 934 shown in FIG. 3 is re-entered.

In Step 948, the controller immediately updates (e.g. copies/moves) the data of the RAM 130 back to the Flash memory 120.

Please note that although installing the RAM 130 might cause a slight material cost increment, it is worthy to install the RAM 130 since the performance of data access can still be maintained in a situation where the scale of process is decreased. More particularly, the operations of this embodiment will not introduce a high storage volume requirement of the RAM 130. For example, it is merely required that the RAM 130 should provide the storage volume of one or a few blocks. According to the present invention, installing such a tiny the RAM 130 helps a lot on fighting against the impact of the unstable characteristics mentioned above in a bad situation where the upper limit of the erase count of each block of Flash memories decreases from a former typical value of 10000 times to less than 5000 times while the scale of process is decreased, or even in an extremely bad situation where the upper limit decreases to less than 3000 times.

In contrast to the related art, once the quality of the Flash memory degrades due to process variation (e.g. the scale of process is decreased to less than 60 nanometers), the present invention method, the associated portable memory device and the controller thereof can still maintain the performance of data access.

It is another advantage of the present invention that, the present invention method, the associated portable memory device and the controller thereof can slow down the increase of the erase counts of the blocks in the Flash memory. Therefore, in contrast to the related art, portable memory devices that are implemented based upon the present invention surely have a longer lifetime.

Those skilled in the art will readily observe that numerous modifications and alterations of the device and method may be made while retaining the teachings of the invention.

What is claimed is:

1. A method for enhancing performance of a Flash memory, the method comprising:
providing a random access memory (RAM);
utilizing the RAM to temporarily store at least one virtual Flash block; and
selectively moving data of the virtual Flash block to the Flash memory in order to write at least one new page in the Flash memory.

2. The method of claim 1, wherein the step of selectively moving the data of the virtual Flash block to the Flash memory in order to write the at least one new page in the Flash memory further comprises:
selectively moving data of the virtual Flash block to the Flash memory in order to write at least one new block in the Flash memory.

3. The method of claim 1, further comprising:
selectively copying data of the virtual Flash block to the Flash memory in order to write at least one new page in the Flash memory.

4. The method of claim 3, wherein the step of selectively copying the data of the virtual Flash block to the Flash memory in order to write the at least one new page in the Flash memory further comprises:
selectively copying data of the virtual Flash block to the Flash memory in order to write at least one new block in the Flash memory.

5. The method of claim 1, further comprising:
when detecting that a host device performs a file-close operation or sends a sleep command or a shutdown command, immediately copying/moving the data of the virtual Flash block to the Flash memory in order to write at least one page in the Flash memory.

6. The method of claim 1, wherein the Flash memory is fabricated by utilizing process technology of a scale that is less than 60 nanometer (nm).

7. The method of claim 1, wherein the Flash memory is installed in a portable memory device; and the step of providing the RAM further comprises:
providing the RAM within the portable memory device.

8. The method of claim 1, wherein the step of utilizing the RAM to temporarily store the at least one virtual Flash block further comprises:
storing host write data into the virtual Flash block according to a host write data request, wherein the host write data request asks for performing a data update operation or a data writing operation regarding a mother block of the Flash memory.

9. The method of claim 8, further comprising:
updating/writing the host write data into a memory region within the virtual Flash block at the same address as that within the mother block according to the host write data request.

10. A portable memory device, comprising:
a Flash memory;
a random access memory (RAM); and
a controller arranged to access the Flash memory, wherein the controller utilizes the RAM to temporarily store at least one virtual Flash block;
wherein the controller selectively moves data of the virtual Flash block to the Flash memory in order to write at least one new page in the Flash memory.

11. The portable memory device of claim 10, wherein the controller selectively moves data of the virtual Flash block to the Flash memory in order to write at least one new block in the Flash memory.

12. The portable memory device of claim 10, wherein the controller selectively copies data of the virtual Flash block to the Flash memory in order to write at least one new page in the Flash memory.

13. The portable memory device of claim 12, wherein the controller selectively copies data of the virtual Flash block to the Flash memory in order to write at least one new block in the Flash memory.

14. The portable memory device of claim 10, wherein when detecting that a host device performs a file-close operation or receiving a sleep command or a shutdown command from the host device, the controller immediately copies/moves the data of the virtual Flash block to the Flash memory in order to write at least one page in the Flash memory.

15. The portable memory device of claim 10, wherein the Flash memory is fabricated by utilizing process technology of a scale that is less than 60 nanometer (nm).

16. A controller of a portable memory device, the controller being utilized for accessing a Flash memory, the controller comprising:
a read only memory (ROM) arranged to store a program code; and
a microprocessor arranged to execute the program code to control access to the Flash memory;
wherein the controller that executes the program code by utilizing the microprocessor utilizes a random access memory (RAM) to temporarily store at least one virtual Flash block; and the controller that executes the program code by utilizing the microprocessor selectively moves data of the virtual Flash block to the Flash memory in order to write at least one new page in the Flash memory.

17. The controller of claim 16, wherein the controller that executes the program code by utilizing the microprocessor selectively moves data of the virtual Flash block to the Flash memory in order to write at least one new block in the Flash memory.

18. The controller of claim 16, wherein the controller that executes the program code by utilizing the microprocessor selectively copies data of the virtual Flash block to the Flash memory in order to write at least one new page in the Flash memory.

19. The controller of claim 18, wherein the controller that executes the program code by utilizing the microprocessor selectively copies data of the virtual Flash block to the Flash memory in order to write at least one new block in the Flash memory.

20. The controller of claim 16, wherein when detecting that a host device performs a file-close operation or receiving a sleep command or a shutdown command from the host device, the controller that executes the program code by utilizing the microprocessor immediately copies/moves the data of the virtual Flash block to the Flash memory in order to write at least one page in the Flash memory.
